(19) United States
(12) Patent Application Publication
(10) Pub. No.: US 2023/0229691 A1
(43) Pub. Date: Jul. 20, 2023

(54) METHODS AND SYSTEMS FOR PREDICTION OF A DESCRIPTION AND ICON FOR A GIVEN FIELD NAME

(71) Applicant: BABU VINOD, Fremont, CA (US)

(72) Inventor: BABU VINOD, Fremont, CA (US)

(21) Appl. No.: 17/943,159

(22) Filed: Sep. 12, 2022

Related U.S. Application Data
(60) Provisional application No. 63/243,174, filed on Sep. 12, 2021.

(51) Int. Cl. G06F 16/535; G06F 16/538; G06N 20/00

(52) U.S. Cl. CPC G06F 16/535; G06F 16/538; G06N 20/00

(57) ABSTRACT

In one aspect, a computerized method for predicting of a description and an icon for a field name. The method includes identifying a field name to provide the description and the icon; predicting the description of the field name with a machine learning (ML) process by: providing a set of field names and matching descriptions; in a training phase, using the set of field names and matching descriptions as a labelled dataset to train a ML model, the ML model comprises a sequence ML model; using the sequence ML model to predict a plurality of description tokens, wherein an initial input to the sequence ML model comprises the field name, wherein the field name is tokenized and passed through an embedding layer that is given as an input to the sequence model, wherein the sequence model predicts a first description token of the description, wherein the first description token is then fed back to the sequence ML model to predict a set of subsequent description tokens of the plurality of description tokens; implementing an icon prediction by: predicting an icon matching the field name by using the field name as a keyword in an image database search and then automatically selecting an icon from one or more query results.

### CLAIM OF PRIORITY

This application claims priority to U.S. Provisional Pat. Application No. 63243174, titled METHODS AND SYSTEMS FOR PREDICTION OF A DESCRIPTION AND ICON FOR A GIVEN FIELD NAME, and filed on 12-SEP-2021. This provisional application is hereby incorporated by reference in its entirety.

### BACKGROUND

It is noted that construction of software applications involves many tedious and time-consuming activities, which are nevertheless required to develop a complete user-friendly application. Programming UI screens and forms is an important aspect of building software applications. A UI screen or a UI form has multiple fields for data entry and data view. In order to make the screen user-friendly it is important to attach a user-understandable description of the field. It is also desirable to attach a relevant icon that visually captures the meaning or semantics of the field. For instance a field name “phone” may have “phone number reachable during daytime” as its description and a phone icon as its icon. The description and the icon may be displayed along with the field in a suitable visually appealing and user-friendly manner. Manually providing this information during application construction is a tedious and time-consuming task for the UI programmer.

### SUMMARY OF THE INVENTION

In one aspect, a computerized method for predicting of a description and an icon for a field name. The method includes identifying a field name to provide the description and the icon; predicting the description of the field name with a machine learning (ML) process by: providing a set of field names and matching descriptions; in a training phase, using the set of field names and matching descriptions as a labelled dataset to train a ML model, the ML model comprises a sequence ML model; using the sequence ML model to predict a plurality of description tokens, wherein an initial input to the sequence ML model comprises the field name, wherein the field name is tokenized and passed through an embedding layer that is given as an input to the sequence model, wherein the sequence model predicts a first description token of the description, wherein the first description token is then fed back to the sequence ML model to predict a set of subsequent description tokens of the plurality of description tokens; implementing an icon prediction by: predicting an icon matching the field name by using the field name as a keyword in an image database search and then automatically selecting an icon from one or more query results.

### BRIEF DESCRIPTION OF THE DRAWINGS

FIG. 1 is a schematic representation of an exemplary hardware environment, according to some embodiments.

FIG. 2 illustrates an example system used to implement a prediction of a description and icon for a given field name, according to some embodiments.

FIG. 3 illustrates an example process for implementing a prediction of a description and icon for a given field name, according to some embodiments.

FIG. 4 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture of a prediction of a description and icon for a given field name. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Embedding can be a method used to represent discrete variables as continuous vectors. Embedding can be used in Natural Language Processing related applications such as language modeling, neural networks etc.

Field names can be a names given to a table column. The names may indicate what (type) data is contained in each column. A field name can identify a field in a database record.

Generative Pre-trained Transformer 2 (GPT-2) is an open-source artificial intelligence system. GPT-2 translates text, answers questions, summarizes passages, and generates text output. GPT-2 can be a general-purpose learner.

Long short-term memory (LSTM) is an artificial recurrent neural network (RNN) architecture used in the field of deep learning. Unlike standard feedforward neural networks, LSTM has feedback connections. It can process not only single data points (such as images), but also entire sequences of data (such as speech or video).

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees’ habit of overfitting to their training set. Deep learning is a family of machine learning methods based on learning data representations. Learning can be supervised, semi-supervised or unsupervised.

Transformer is a deep learning model that adopts the mechanism of attention, differentially weighing the significance of each part of the input data. It is used primarily in the field of natural language processing (NLP) and in computer vision (CV).

User interface (UI) is the space where interactions between humans and machines occur. A UI can include a graphical user interface (GUI) as a form of UI that allows users to interact with electronic devices through graphical icons and audio indicator such as primary notation.

### Example Systems and Methods

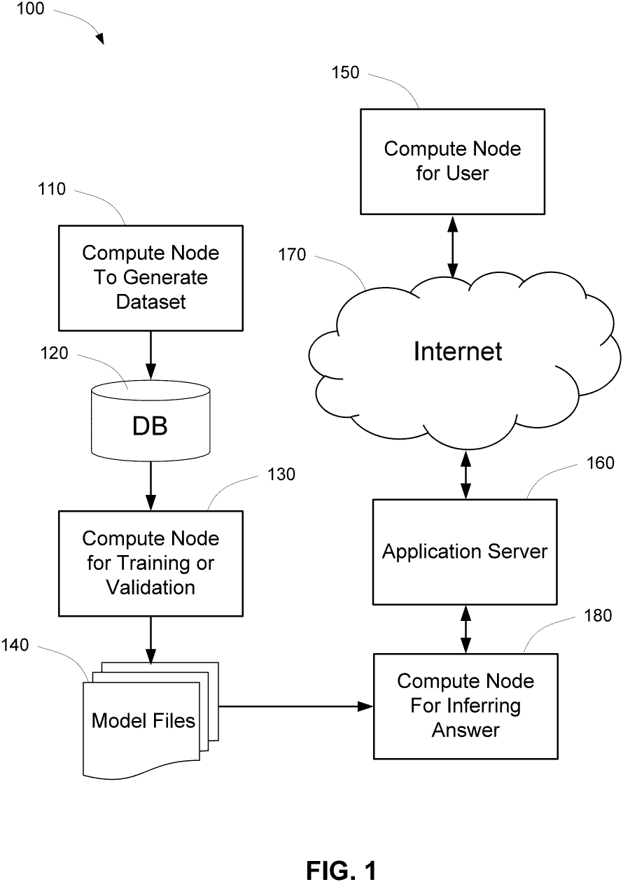

FIG. 1 is a schematic representation of an exemplary hardware environment 100, according to some embodiments. The hardware environment 100 includes a first compute node 110 that is employed to generate field descriptions and graphical icons to build a dataset. In various embodiments the compute node 110 is a server but can be any computing device with sufficient computing capacity such as a server, personal computer, or smart phone. The compute node 110 can field names and other UI information to the dataset. The compute node 110 stores the dataset to a database 120. A second compute node 130, which can be the same compute node as first compute node 110, in some embodiments, accesses the database 120 in order to utilize the dataset to train deep learning models to produced trained model files 140. The second compute node 130 can optionally also validate deep learning models.

A user employing a third compute node 150 can be a UI developer and upload various field names and/or icon data to an application server 160 across a network like the Internet 170, where the application server 160 hosts a search engine, for example a visual search engine or recommendation engine, or an application like an UI programming application. In response to a request from the compute node 150, PC, to find information on the field name and/or icon, the application server 160 connects the third compute node 150 to a fourth compute node 180, which can be the same compute node as either the first or second compute nodes 110, 130, in some embodiments. Compute node 180 uses the model files 140 to infer answers to the queries posed by the compute node 150 and transmits the answers back through the application server 160 to the compute node 150. In this way, deep learning can be used to predict a description and icon for a given field name.

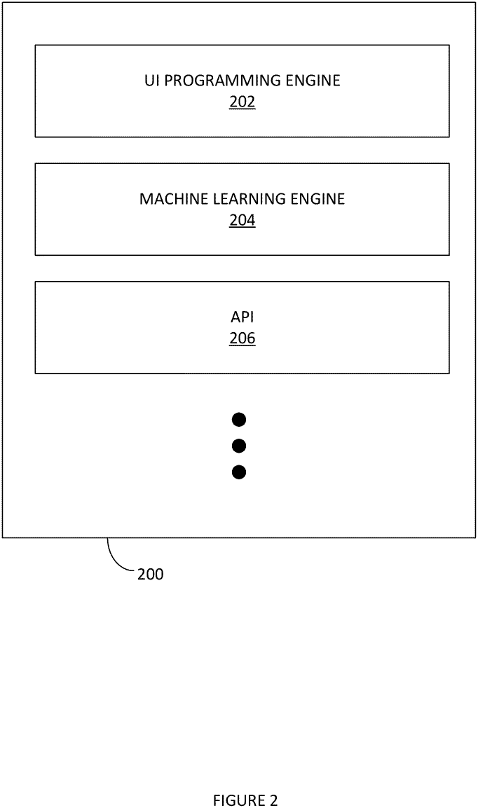

FIG. 2 illustrates an example system 200 used to implement a prediction of a description and icon for a given field name, according to some embodiments. System 200 can include UI programming module 202. UI programming module can be used to program UI/UX elements. UI programming module 202 can be used to craft intuitive controls for software and hardware systems. UI programming module 202 can be used to create an interface that behaves as users would it expect it to, facilitating a seamless and efficient user experience.

System 200 can include ML engine 204. ML engine 204 can use various ML methods to generate models that can optimize and/or automate UI programming. For example, ML engine 204 can used for prediction of a description and icon for a given field name during UI programming development.

In one example, ML engine 204 for automatically generating description and icon for a field, given the field name. ML engine 204 can use system 100 described supra. API 206 can be used by a UI development application to access the services of system 200.

System 200 can be used as a standalone service (e.g. a web service) and/or as part of a larger low code application development platform. The field name is input to a trained (ML) model to predict the description and another ML model to predict the icon (e.g. as discussed in the description of system 100, etc.).

System 200 can include an image search engine. Image search engine can be a search engine that allows process 300 to search the World Wide Web for images. Image search engine can perform reverse image searches. Image search engine can analyze images. The submitted image is analyzed to find identifiers such as colors, points, lines, and textures. Image search engine can generate query(s). These distinct features of the image are used to generate a search query. Image search engine can match image(s). The query is matched against the images in a back-end functionality. Image search engine can return results. The search and match algorithms return matching and visually similar images as results to the user.

It is noted that the reverse image search can be a content-based image retrieval (CBIR) query technique that involves providing the CBIR system with a sample image that it will then base its search upon; in terms of information retrieval, the sample image is very useful in its ways. Reverse image search can be characterized by a lack of search terms. This effectively removes the need for a user to guess at keywords or terms that may or may not return a correct result. Reverse image search also allow the image search engine and/or process 300 to discover content that is related to a specific sample image, popularity of an image, and discover manipulated versions and derivative works.

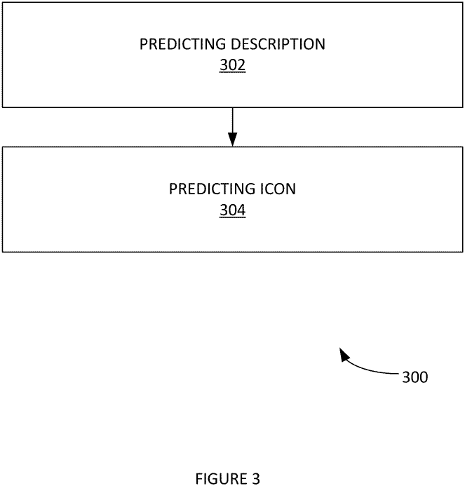

FIG. 3 illustrates an example process 300 for implementing a prediction of a description and icon for a given field name, according to some embodiments. Process 300 can be used by system 100. ML engine 304 can implement process 300.

In step 302, process 300 can predict a description. In the training phase a set of field names and matching descriptions are used as the labelled dataset to train an ML model. A sequence ML model that can predict a sequence of output tokens is employed. Examples include LSTM or a Transformer model. The initial input to the sequence model is the field name. The field name is tokenized and passed through an embedding layer, which is given as input to the sequence model. The sequence model predicts the first token of the description, which is then fed back to the model to predict the subsequent tokens. An auto-regressive sequence model is therefore employed. During the training phase the model is trained to minimize the error between the predicted and expected description token sequences. During the prediction phase, given a field name input the model predicts a sequence of description tokens. A pre-trained language model such as GPT-2 could be used to reduce the training time and training data set size.

In step 304, process 300 can implement an icon prediction. Predicting icon A method to predict the icon matching a field name, is to use the field name as the keyword in a Google image search and then choose an icon from the query results. The sites in the search results could be automatically examined to ensure that the image is royalty free. Image quality requirements (e.g. minimum image size) could also be used as a filtering criterion. Alternatively, the description prediction model can be used to predict the description and the Google® image search can be done using the predicted description along with the field name. This may narrow down the results to more interesting and relevant ones. Another method is to have a library of icons and train a classifier ML model to predict one of the icons in the library given the field name. The field name is converted to its embedding representation using a pre-trained word embedding and given as input to the classifier. In one embodiment different techniques are chained together. For instance the ML classifier can be employed first and if it does not give a proper prediction, it can be chained with the Google image search. The classifier has a “not available” prediction. If the classifier gives this prediction Google image search can be used as a fallback option. A model may also be jointly trained using multi-tasking learning on the two tasks of learning to generate the description as well as the image.

### Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees’ habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model’s hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

### Additional Example Computer Architecture and Systems

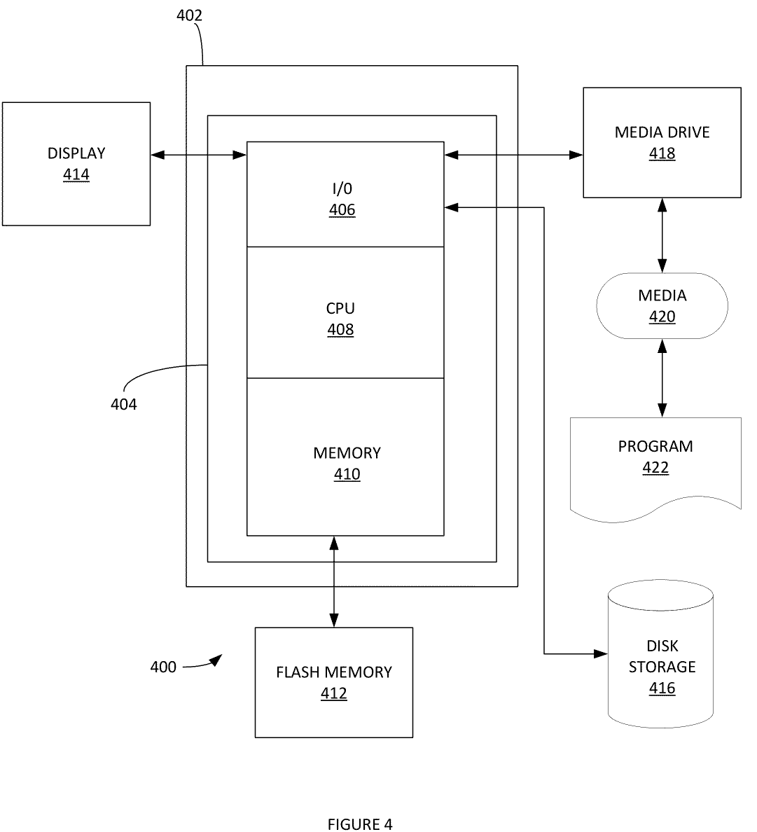

FIG. 4 depicts an exemplary computing system 400 that can be configured to perform any one of the processes provided herein. In this context, computing system 400 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a nontransitory form of machine-readable medium.

What is claimed by united states patent:

1. A computerized method for predicting of a description and an icon for a field name comprising:
identifying a field name to provide the description and the icon;
predicting the description of the field name with a machine learning (ML) process by:
providing a set of field names and matching descriptions;
in a training phase, using the set of field names and matching descriptions as a labelled dataset to train a ML model, wherein the ML model comprises a sequence ML model;
using the sequence ML model to predict a plurality of description tokens, wherein an initial input to the sequence ML model comprises the field name, wherein the field name is tokenized and passed through an embedding layer that is given as an input to the sequence model, wherein the sequence model predicts a first description token of the description, wherein the first description token is then fed back to the sequence ML model to predict a set of subsequent description tokens of the plurality of description tokens;
implementing an icon prediction by:
predicting an icon matching the field name by using the field name as a keyword in an image database search and then automatically selecting an icon from one or more query results.

2. The computerized method of claim 1, wherein the sequence ML model comprises a Long Short-Term Memory (LSTM) model.

3. The computerized method of claim 1, wherein the sequence ML model comprises a transformer model.

4. The computerized method of claim 1, wherein the ML model comprises an auto-regressive sequence model.

5. The computerized method of claim 4, wherien during the training phase the ML model is trained to minimize an error between the predicted and expected description token sequences.

6. The computerized method of claim 5, wherein during the prediction phase, given a field name input the ML model predicts the sequence of description tokens.

7. The computerized method of claim 6, wherein a pre-trained language model is utilized.

8. The computerized method of claim 7, wherein pre-trained language model comprises a Generative Pre-trained Transformer 2 (GPT-2) that is used to reduce the training time and training data set size.

9. The computerized method of claim 8, wherein the image database search comprises an online image database search implemented by an online database search engine.

10. The computerized method of claim 9 further comprising:
automatically examining the online image database to ensure that the image that is selected is a royalty free image.

11. The computerized method of claim 10, wherein a description prediction model is used to predict a description and the image search is performed using the predicted description along with the field name.

12. The computerized method of claim 11, wherein a library of icons are used to train a classifier ML model to predict one of the icons in the library given the field name.

13. The computerized method of claim 12, wherein the field name is converted to an embedding representation using a pre-trained word embedding and given as input to the classifier ML model.
